(19) United States
(12) Patent Application Publication
(10) Pub. No.: US 2026/0012792 A1
(43) Pub. Date: Jan. 8, 2026

(54) METHOD AND SYSTEM FOR SECURE RESPONSE TO A COMMAND TO A SMART METER

(71) Applicant: SAGEMCOM ENERGY & TELECOM SAS, Bois-Colombes (FR)

(72) Inventor: Ziv ROTER, Bois-Colombes (FR)

(73) Assignee: SAGEMCOM ENERGY & TELECOM SAS, Bois-Colombes (FR)

(21) Appl. No.: 19/259,955

(22) Filed: Jul. 3, 2025

(30) Foreign Application Priority Data
Jul. 8, 2024 (FR) 2407439

(51) Int. Cl. H04W 12/106; H04W 12/08

(52) U.S. Cl. CPC H04W 12/106; H04W 12/08

(57) ABSTRACT

To transmit a response to a command received that includes a descriptor of an operation to be performed, a smart meter recovers output attributes, and metadata associated with the response, to be supplied as results of the implementation of the command received. The smart meter includes, in the metadata associated with the response, the descriptor of an operation to be performed that had been supplied in the command received, and implements a protection that generates a signature on a set of data formed by the output attributes and the metadata associated with the response.

### TECHNICAL FIELD

At least one embodiment relates to a method and system for secure response to a command sent to a smart meter. The system in question is adapted to enable a management device to ensure that responses to commands transmitted to a smart meter are not manipulated on the way and to know with certainty which operations have been performed by the smart meter on reception of the commands.

### PRIOR ART

Smart meters are known, of the electricity meter type (electrical-consumption meters) or fluid meters (fluid-consumption meters), which comprise communication interfaces enabling an automated management system to make a remote collection of consumption data. For example, smart electricity meters comprise a communication interface of the powerline communication (PLC) type. Exchanges can thus be made between the smart meters and an information system IS managing them in a centralised manner. This enables the information system IS to send commands to the smart meters to make them perform various operations, such as operations of transmitting meter readings, operations of changing operational parameters (for example a change to the energy-consumption lower threshold or a change of calendar profile), software-update operations, events-diary deletion operations, functionality activation/deactivation operations (for example power cut), etc.

So as to take precautions against an alteration to command attributes, the COSEM (“Companion Specification for Energy Metering”) specifications require certain commands to be accepted only if they use a COSEM data-protection object (object called “DATA PROTECTION”, such as for example set out in the work “Bluebook DLMS” V16 Part 2 § 4.4.9), which affix a signature (asymmetric encryption) to results of execution of commands (output attributes), and to associated metadata (transaction number, date of command, cryptographic identity of the signatory, cryptographic identity of the recipient). For the record, the COSEM specifications define a model in the form of objects to formalise instructions (commands) and more generally data exchanges. The objects are combinable so as to make it possible to perform an entire panel of operations, whether they be simple, such as register readings, or more complex, such as load-management operations. The COSEM specifications are sufficiently generic to make it possible to model various use cases beyond energy management (water-distribution management, for example).

Protecting attributes, and associated metadata, in particular allowed by the COSEM specifications by means of the object of the “DATA PROTECTION” type, is an important tool for protecting transmissions of responses to commands transmitted by a management device in an automated (remote) smart-meter management system. This prevents altered responses being taken into account by the management device.

However, making the transmission of responses secure by protecting output attributes is an imperfect solution. This is because various commands may return similar output attributes, through their shapes, their sizes, etc. And the protection of output attributes offered by the object of the “DATA PROTECTION” type has no effect against an alteration of the command itself, typically a command-identifier alteration. For example, if the operation required by the management device relates to a reading of a 32-bit register and the smart meter returns the value of another 32-bit register because of an altered command, the management device may erroneously interpret the operational state of the smart meter.

It is therefore desirable to provide a solution that makes it possible to reinforce the protection of responses to commands transmitted in a system for remote automated management from a management device to smart meters, so as not to take into account information provided by the smart meters and which would not actually correspond to the commands initially transmitted.

### DISCLOSURE OF THE INVENTION

For this purpose, a method is proposed for transmitting a response to a command received by a smart meter in an automated management system, the command comprising a descriptor of an operation to be performed by said smart meter, the method comprising the following steps performed by said smart meter, after performance of the operation demanded, to provide the response to the command received:
recovering output attributes, and metadata associated with the response, to be supplied as results of the implementation of the command received;
including, in the metadata associated with the response, the descriptor of the operation to be performed that had been supplied in the command received;
implementing a protection that generates a signature on a set of data formed by the output attributes and the metadata associated with the response;
transmitting, in response to the command received, the response including the output attributes, said associated metadata including the descriptor of the operation to be performed that had been supplied in the command received, and the signature generated.

Thus, by virtue of the presence, in the metadata associated with the response, of the descriptor of the operation to be performed that had been supplied in the command received, as well as the signature, it is possible to know which operation had actually been performed by the smart meter and, if an alteration to the command and/or to the response has occurred, to be able to detect it. It is thus possible not to take into account information provided by the smart meters and which would not actually correspond to the commands that were initially transmitted to them.

According to a particular embodiment, the command furthermore includes metadata associated with the command, including a copy of the descriptor of the operation to be performed, the smart meter verifies that the descriptor of the operation to be performed and the copy thereof in the metadata associated with the command received are identical and, when such is not the case, the smart meter rejects the command received.

Thus, the command is protected, which avoids the smart meter performing an operation that would not correspond to the command initially transmitted.

According to a particular embodiment, the smart meter constructs the metadata associated with the response by copying the metadata associated with the command received.

Thus, the smart meter can easily indicate, in response to the command, which operation has been performed.

In a particular embodiment, the descriptor of the operation to be performed contains an identifier of the operation to be performed

Thus, although a simple identifier of the operation to be performed could easily undergo alteration, the clever copying of the descriptor of the operation to be performed within metadata that benefit from protection by signature is sufficient to make it possible to detect that an alteration has occurred.

According to a particular embodiment, the automated management of smart meters is implemented in accordance with an object-oriented modelling, the descriptor of the operation to be performed contains a class identifier of at least one object manipulated to perform the operation in question.

Thus, although a simple identifier of classes of objects manipulated to perform the required operation could easily undergo alteration, the clever copying of the descriptor of the operation which was to be performed within metadata that benefit from protection by signature is sufficient to make it possible to detect that an alteration has occurred.

According to a particular embodiment, the object-oriented modelling is of the COSEM type and the protection that generates the signature is obtained by an object of the DATA PROTECTION type.

Thus, the clever copying of the descriptor of the operation that was to be performed, in the metadata of the response, makes it possible to ensure the protection sought in the context of a use of a COSEM object of the DATA PROTECTION type.

According to a particular embodiment, the method furthermore comprises the following steps, on reception of the response, of verifying the response, performed by a management device that transmitted the command to said smart meter.
recovering, in the response received, the output attributes that result from the operation performed, as well as the metadata associated with the response;
recovering in memory the descriptor of the operation to be performed that had initially been transmitted in the command to which the response corresponds;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

Thus, the management device is able to detect whether an alteration has occurred in the command (faulty command executed by the smart meter) and/or in the response.

According to a particular embodiment, the verification of the response is also implemented by a data concentrator acting as a relay between the management device and the smart meter in question in the automated management system.

Thus, it is verified that the command has not been altered between the smart meter and the data concentrator and, if such has been the case, this verification avoids unnecessarily acting on the management device (and network resources between the data concentrator and the management device).

A smart meter is also proposed herein, configured to process a command received in an automated management system, the command received comprising a descriptor of an operation to be performed by the smart meter. The smart meter comprises electronic circuitry configured to perform the following steps, after performance of the operation demanded, to provide the response to the command received:
recovering output attributes, and metadata associated with the response, to be supplied as results of the implementation of the command received;
including, in the metadata associated with the response, the descriptor of the operation to be performed that had been supplied in the command received;
implementing a protection that generates a signature on a set of data formed by the output attributes and the metadata associated with the response;
transmitting, in response to the command received, the response including the output attributes, said associated metadata including the descriptor of the operation to be performed that had been supplied in the command received, and the signature generated.

A management device is also proposed herein comprising electronic circuitry configured to implement a transmission of a command in an automated management system, the command comprising a descriptor of the operation to be performed by a smart meter, the electronic circuitry being configured to perform the following steps, on reception of the response, of verifying the response:
recovering, in the response received, output attributes that result from an operation performed by the smart meter on reception of the command, as well as the metadata associated with the response;
recovering in memory the descriptor of the operation to be performed that had initially been transmitted in the command;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

A system for automated management of smart meters is also proposed herein, comprising a management device as disclosed above and smart meters as disclosed above.

A method implemented by a management device in an automated management system is also proposed here, wherein the management device implements a transmission of a command comprising a descriptor of an operation to be performed by a smart meter. The method is such that the management device performs the following steps, on reception of a response to the command:
recovering, in the response received, output attributes that result from an operation performed by the smart meter on reception of the command, as well as the metadata associated with the response;
recovering in memory the descriptor of the operation to be performed that had initially been transmitted in the command;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

A computer program product is also proposed herein, comprising instructions causing the implementation by a processor of one or other of the methods disclosed above, in any one of the embodiments thereof, when the instructions are executed by the processor.

An information-storage medium is also proposed herein, storing instructions causing the implementation by a processor of one or other of the methods disclosed above, in any one of the embodiments thereof, when the instructions are read from the information-storage medium and executed by the processor.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an automated management system for smart meters;

FIG. 2 shows a logic representation of interactions between a management device and a smart meter of the automated management system;

FIG. 3 illustrates schematically an example of hardware architecture, which is adapted to implement a device of the automated management system;

FIG. 4 illustrates schematically a principle of generating and affixing a signature;

FIG. 5 illustrates schematically a flow diagram of a method for formatting and transmitting a command initiated by the management device and intended for the smart meter, in a particular embodiment;

FIG. 6 illustrates schematically a flow diagram of a verification method for accepting or rejecting a command received, in a particular embodiment;

FIG. 7 illustrates schematically a flow diagram of a method for formatting and transmitting a response to a command that was initiated by the management device and intended for the smart meter; and

FIG. 8 illustrates schematically a flow diagram of a verification method for accepting or rejecting a response received.

### DETAILED DISCLOSURE OF EMBODIMENTS

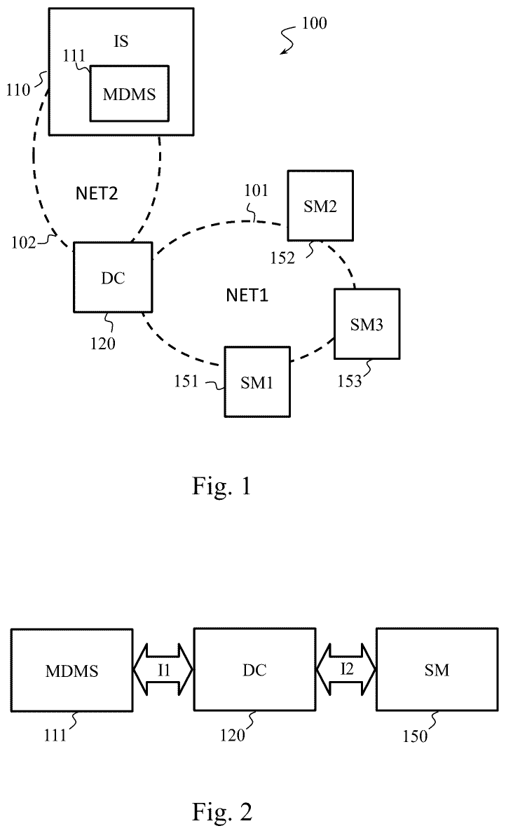

FIG. 1 illustrates schematically an automated management system 100 wherein the present invention can be implemented. The automated management system 100 is configured to implement a remote management of smart meters 151, 152, 153 (e.g. electricity, water, gas, heat, other fluids).

The remote management of smart meters 151, 152, 153 is provided by a management device 111 of an information system IS 110. In many solutions of such automated management systems, the management device 111 is a meter data management system MDMS.

The information system 110 typically furthermore includes a key management system KMS that is configured to store encryption keys necessary for the smart meters that depend on the information system IS 110 in question. The key management system KMS is configured to supply to the management device 111, such as the meter data management system MDMS, the keys necessary for the encryptions/decryptions that have to be implemented with regard to the smart meters 151, 152, 153. In a variant, the management device 111 has, by prior configuration, keys necessary for the encryptions/decryptions that have to be implemented with regard to the smart meters 151, 152, 153.

The management device 111 manages the smart meters 151, 52, 153 through a network infrastructure managed by a data concentrator DC 120. The data concentrator DC 120 thus manages a first communication network NET1 101 via which the communications with the smart meters 151, 152, 153 are established. The data concentrator DC 120 thus serves as a relay between the smart meters 151, 152, 153 and the information system IS 110 (including the management device 111).

As illustrated schematically in FIG. 1, the data concentrator DC 120 is external to the information system IS 110 and communicates with the information system IS (including the management device 111) by means of a second communication network NET2 102.

Typically, the information system IS 110 interacts with several data concentrators DC 120 through the second communication network NET2 102, each of the data concentrators DC 120 managing the communications with its own group of smart meters.

For example, the first communication network NET1 101 is a network of the powerline communications PLC type, such as is compliant with the G3-PLC or PRIME specifications. According to another example, the first communication network NET1 101 is a wireless network of the LPWAN (low-power wide area network) type such as is found in the Internet of Things IoT).

For example, the second communication network NET2 102 is a wireless communication network of the 5G (5th generation) type. According to other examples, the communication network NET2 102 is a wireless network of the GPRS (“General Packet Radio Service”), UMTS (“Universal Mobile Telecommunication System”) or LTE (“Long-Term Evolution”) type.

Other technologies can be used to implement the first communication network NET1 101 and the second communication network NET2 102.

A logic representation of the interactions between the management device 111, such as the MDMS system, and a said smart meter 150 by means of the data concentrator DC 120 is shown on FIG. 2. These three elements may be different suppliers (manufacturers) and are typically located at different places.

An interface I1 is defined for the exchanges between the management device 111 and the data concentrator DC 120, and an interface I2 is defined for the data concentrator DC 120 and the smart meter 150.

In a DLMS (“Device Language Message Specifications”) implementation, the management device 111 has a role of third (or third-party) device with regard to the pair consisting of DLMS client and DLMS server formed by respectively by the data concentrator DC 120 and the smart meter 150.

The interface I1 then enables the third party to give instructions to the DLMS client and to recover the results therefrom. These instructions are typically in a proprietary format (for example based on XML (“extensible Markup Language”), JSON (“JavaScript Object Notation”) or other) in a secure application transport protocol of the HTTPS (“Hypertext Transfer Protocol Secure”) type but manipulates commands and business data to the COSEM/A-XDR format (where A-XDR is an encoding format, referenced by the DLMS/COSEM specifications, and defined in IEC 61334-6).

The interface I2 enables the DLMS client to connect to the DLMS meter/server, to send instructions and to recover the results using the DLMS protocol to manage the commands and the business data to the COSEM/A-XDR format.

The DLMS client provides the transport format conversions between the first NET1 101 and second NET2 102 communication networks. In particular, a protection layer by symmetric encryption can be added for the transmissions on the first communication network NET1 101.

To ensure the integrity of the responses transmitted by the smart meter 150 to commands transmitted by the management device 111, a signature is generated and affixed as detailed below in relation to FIG. 4, for example by means of a COSEM object of the “DATA PROTECTION” type.

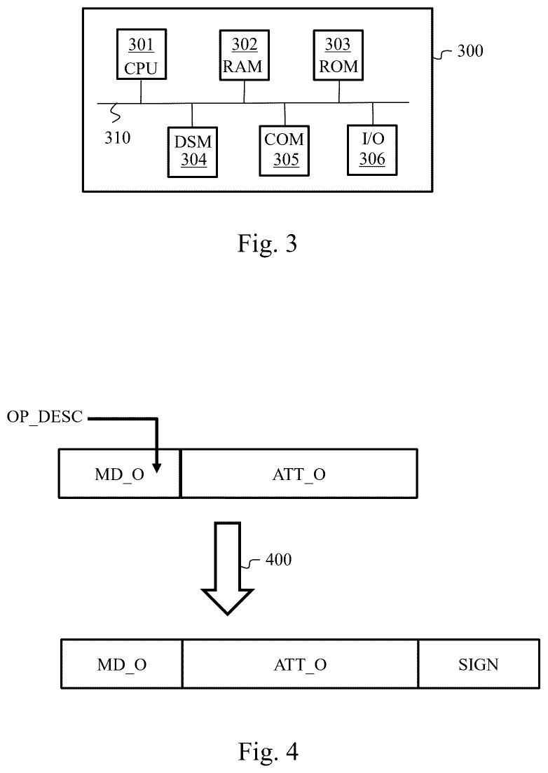

FIG. 3 illustrates schematically an example of hardware architecture 300, which is adapted to implement any device controller of the automated management system 100. The example of hardware architecture is thus adapted to implement a controller of the information system IS 110, or of any component of the information system IS 110. The example of hardware architecture is also adapted to implement a controller of the data concentrator DC 120 The example of hardware architecture is also adapted to implement a controller of the smart meter 150, 151, 152, 153.

The hardware architecture 300 therefore comprises, connected by a communication bus 310: a processor or CPU (“central processing unit”) 301; a random access memory (RAM) 302; a read only memory (ROM) 303, or EEPROM (“electrically erasable programmable ROM”), or a flash memory; a data storage medium DSM 304, such as a hard disk drive HDD, or a storage medium reader, such as an SD (Secure Digital) card reader; and at least one communication interface COM 305. Depending on the device in question, the hardware architecture 300 may furthermore comprise inputs/outputs I/O 306, for example to make consumption measurements (smart meters).

The processor 301 is capable of executing instructions loaded in the RAM 302 from the ROM 303, from an external memory (not shown), from a storage medium (such as an SD card), or from a communication network. When the hardware architecture 300 is powered up, the processor 301 is capable of reading instructions from the RAM 302 and executing them. These instructions form a computer program causing the implementation, by the processor 301, of the steps and algorithms described here in relation to the device concerned.

All or some of the steps and algorithms described here can thus be implemented in software form by executing a set of instructions by a programmable machine, such as a DSP (“digital signal processor”) or a microcontroller, or be implemented in hardware form by a machine or a component (chip) or a set of components (chipset), such as an FPGA (field-programmable gate array) or an ASIC (application-specific integrated circuit). In general terms, each device of the automated management system 100 comprises electronic circuitry arranged and configured to implement the steps and algorithms described here in relation to the device in question.

FIG. 4 illustrates schematically a principle of protecting a response to a command by generating and affixing a signature.

As proposed by the COSEM specifications, a signature is affixed by asymmetric encryption by means of a private key to a set of data formed by output attributes ATT_O, results of an operation demanded, as well as metadata MD_O associated with the response.

In the COSEM specifications, these metadata are a transaction number (“transaction-id” metadata), cryptographic identity of the signature (“originator-system-title” metadata), time of the command (“date-time” metadata), cryptographic identity of the recipient (“recipient-system-title” metadata). Other metadata can be added (“other-information” metadata existing or in a metadata field “object-list” added for this purpose). The metadata are typically first supplied (MD_I metadata), at least partly, in the command and are therefore data that are not necessary for performing the operation itself, since the data necessary for performing the operation itself are located elsewhere in the command, but which provide supplementary information.

The operation to be performed is presented in the command in a descriptor OP_DESC (e.g. COSEM object(s)). As described below, in a particular embodiment, a copy of this descriptor OP_DESC is included in the metadata MD_I (more particularly in the existing “other-information” metadata or via the addition of a new metadata field “object-list”) provided in the command.

In a particular embodiment, the descriptor of the operation to be performed OP_DESC and any copy thereof, in the command, contain an identifier of the operation to be performed (for example a method number).

In a particular embodiment where the automated management of the smart meters is implemented in accordance with an object-oriented modelling (as in the COSEM specifications), the descriptor of the operation to be performed OP_DESC and any copy thereof, in the command, contain a class identifier of at least one object manipulated to perform the operation in question.

In a particular embodiment where the automated management of the smart meters is implemented in accordance with an object-oriented modelling (as in the COSEM specifications), the descriptor of the operation to be performed OP_DESC is a list of COSEM objects representing the operation to be performed.

It is proposed here to include in the metadata MD_O (more particularly in the existing “other-information” metadata or via the addition of a new metadata field “object-list”) a copy of this descriptor of the operation to be performed OP_DESC. This copy of the descriptor of the operation that was to be performed OP_DESC, according to the command received, is thus included in the coverage area of the protection by signature.

Thus, after a signature SIGN is generated 400 from input attributes ATT_O at the output of the operation to be performed according to the command received and metadata MD_O (including therefore the copy of the descriptor of the operation that was to be performed OP_DESC), the signature SIGN is affixed as an accompaniment to the output attributes ATT_O and metadata MD_O. It is then possible to verify on receiving the response, by means of the public key corresponding to the private key used for generating the signature, that not only have the output attributes not been altered but also to verify, by means of the copy describing the operation to be performed OP_DESC included in the metadata MD_O and the signature, to avoid the management device being mistaken about the operation that was performed by the smart meter 150 and therefore to determine whether this operation conforms to the one initially requested by the management device 111. The management device 111 is therefore able to decide whether the output attributes ATT_O received in the response can be taken into account.

The response-protection principle presented above is advantageously applied to non-critical operations with respect to the smart meter, more particularly operations of reading information (e.g. commands of the “GET” type). It is however important for the management device 111 to be able to determine what confidence to grant to the output attributes ATT_O contained in the response, in particular whether they actually correspond to the results of executing the command initially transmitted by the management device 111. For example, in the context of the DLMS/COSEM specifications, the command-protection principle presented above is advantageously applied in the context of reading a load curve or diary of events via an object of class 7 “PROFILE GENERIC”.

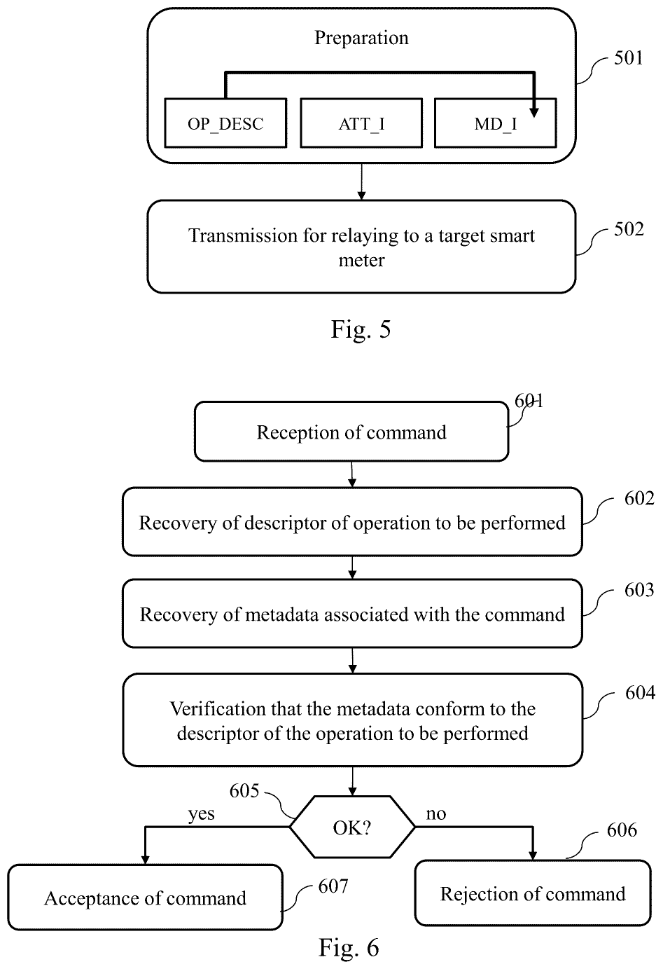

FIG. 5 illustrates schematically a flow diagram of a method for formatting and transmitting a command initiated by the management device 111 and intended for a said smart meter 150, in one embodiment.

In a step 501, the management device 111 prepares the command. The command corresponds to the operation to be performed by the smart meter in question 150 (target smart meter). The management device 111 generates a descriptor of the operation to be performed OP_DESC as mentioned above in relation to FIG. 4.

The management device 111 prepares the metadata MD_I associated with the command. The management device 111 includes, in the metadata MD_I, a copy of the descriptor of the operation to be performed OP_DESC. This particular embodiment makes it possible on reception to verify that the descriptor of the operation to be performed OP_DESC has not been altered during transmission (the copy corresponds to the descriptor of the operation to be performed OP_DESC that is also found in the command).

Optional input attributes ATT_I can be added to the command, if the command is of a type that so requires.

In a step 502, the management device 111 transmits the command thus formed to the data concentrator DC 120 for relaying as far as the smart meter 150 in question (target smart meter).

The management device 111 keeps in memory the descriptor of the operation to be performed OP_DESC as sent, until a response from the smart meter 150 in question reaches it (or an expiry time greater than a predefined duration threshold is reached).

FIG. 6 illustrates schematically a flow diagram of a verification method for accepting or rejecting a command received, in a particular embodiment. The command was generated and transmitted in accordance with the method described above in relation to FIG. 5 to a said smart meter 150 (target smart meter).

In a step 601, the smart meter 150 in question receives the command.

In a step 602, the smart meter 150 recovers, in the command received, (what is supposed to be) the descriptor of the operation to be performed OP_DESC (apart from the metadata part MD_I of the command).

In a step 603, the smart meter 150 recovers, in the command received, (what is supposed to be) the metadata MD_I associated with the command.

In a step 604, the smart meter 150 verifies that the metadata MD_I recovered at the step 603 (i.e. those that are supposed to include the copy of the descriptor of the operation to be performed OP_DESC) conform to the descriptor of the operation to be performed OP_DESC recovered at the step 602. In other words, the smart meter 150 verifies that the copy of the operation to be performed OP_DESC in the metadata MD_I recovered at the step 603 is identical to the descriptor of the operation to be performed OP_DESC recovered at the step 602. This makes it possible to verify that the descriptor of the operation to be performed OP_DESC has not been altered (solely) at one of the two places where it is inscribed or copied in the command.

Then, in a step 605, the smart meter 150 tests whether the verification of the step 604 is positive. When the metadata MD_I recovered at the step 603 do not conform to the descriptor of the operation to be performed OP_DESC recovered at the step 602, the smart meter 150 rejects the command in a step 606. Otherwise, in a step 607, the smart meter 150 in question accepts the command.

Other checks can be made by the smart meter 150, in particular concerning the metadata MD_I. For example, the smart meter 150 can verify that the date of the command (“date-time” metadata) is not too old compared with an elapsed time limit threshold. Thus the smart meter 150 can verify that the cryptographic identity of the signatory (“originator-system-title” metadata and/or cryptographic identity of the recipient (“recipient-system-title” metadata) conform to expected identities.

The verification method of FIG. 6 is implemented when the management device 111 is supposed to copy the descriptor of the operation to be performed OP_DESC in the input metadata MD_I. Otherwise, the smart meter 150 in question can simply make checks concerning the date of the command and/or the cryptographic identity of the signatory and/or the cryptographic identity of the recipient.

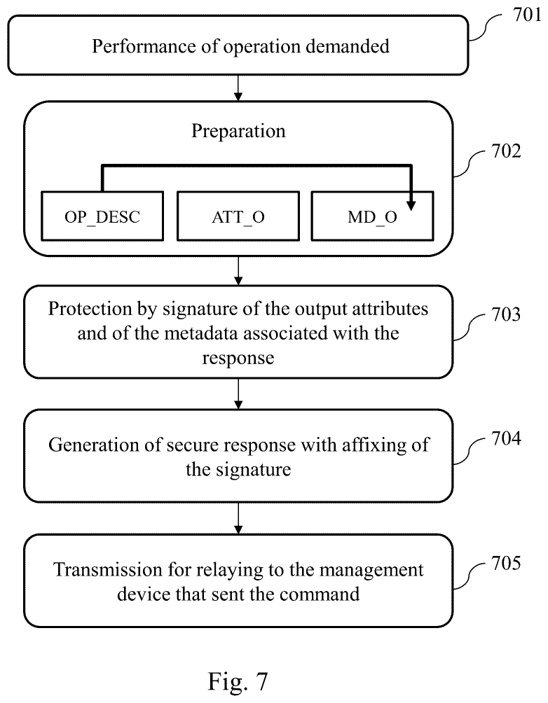

FIG. 7 illustrates schematically a flow diagram of a method for formatting and transmitting a response to a command that was initiated by the management device 111 and intended for a said smart meter 150.

In a step 701, the smart meter 150 in question performs the operation demanded. When the management device 111 is supposed to copy the descriptor of the operation to be performed OP_DESC in the input metadata MD_I, the smart meter 150 in question performs the operation demanded after having implemented the verification method of FIG. 6 and having accepted the command in the step 607.

In a step 702, the smart meter 150 prepares the response to the command. The smart meter 150 repeats the descriptor of the operation to be performed OP_DESC that had been supplied in the command.

The smart meter 150 recovers output attributes ATT_O, and associated metadata MD_O, to be supplied to the management device 111 as command-execution results.

The output attributes ATT_O can include a success code or an error code with regard to the command-execution results.

The output attributes ATT_O may include other information, such as for example a register value resulting from the execution of the operation demanded. For example, the output attributes ATT_O repeat a content of a diary of events the reading of which was requested by said command.

The smart meter 150 includes, in the metadata MD_O, the descriptor of the operation to be performed OP_DESC that had been supplied in the command.

Preferentially, the metadata MD_O of the response include a transaction number (“transaction-id” metadata) that repeats a transaction number that had been included in the metadata MD_I of the corresponding command, in order to make it possible to determine to which command the response corresponds.

In a particular embodiment, the smart meter 150 constructs the metadata MD_O by copying the metadata MD_I (including the descriptor of the operation to be performed OP_DESC, if it has been copied therein).

In a step 703, the smart meter 150 protects the output attributes ATT_O and the metadata MD_O (including therefore the descriptor of the operation to be performed OP_DESC) by generating the signature as already described (asymmetric encryption with the private key of the smart meter 150).

In a step 704, the smart meter 150 affixes, to the response, the signature generated. In a step 705, the smart meter 150 transmits the response thus protected to the data concentrator DC 120 for relaying as far as the management device 111.

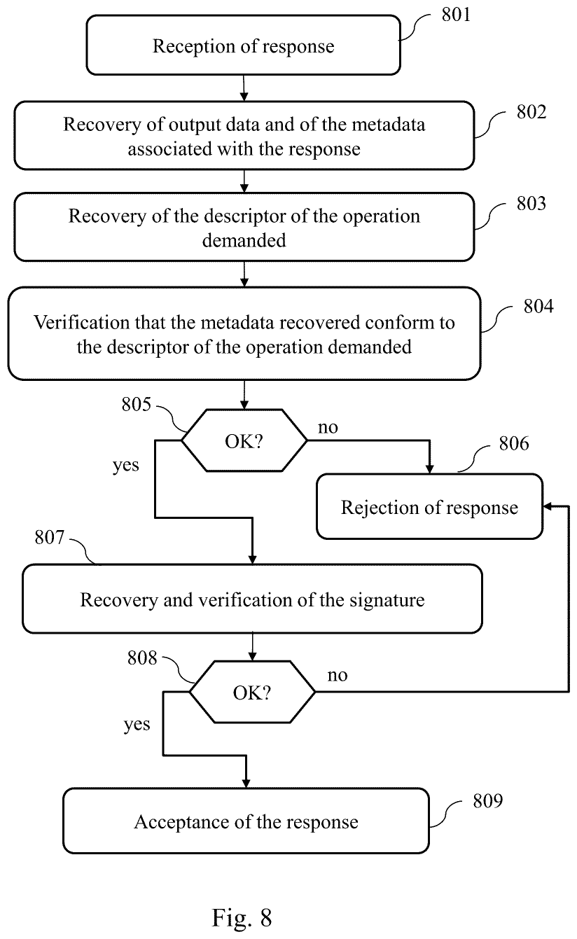

FIG. 8 illustrates schematically a flow diagram of a verification method for accepting or rejecting a response received. The response was generated and transmitted in accordance with the method described above in relation to FIG. 7.

In a step 801, the management device 111 receives the response in question.

In a step 802, the management device 111 recovers, in the response received, (what is supposed to be) the output attributes ATT_O that result from the operation performed, as well as (what is supposed to be) the metadata MD_O associated with the response.

In a step 803, the management device 111 recovers, in memory, the descriptor of the operation to be performed OP_DESC that had initially been transmitted in the command to which the response is supposed to correspond. Preferentially, the metadata MD_O of the response include a transaction number that is equal to a transaction number that had been included in the metadata MD_I of the corresponding command, which makes it possible to easily find which is the descriptor OP_DESC in question.

In a step 804, the management device 111 verifies that the metadata MD_O recovered at the step 802 correspond to the descriptor of the operation to be performed OP_DESC recovered at the step 803.

Then, in a step 805, the management 111 tests whether the verification of the step 804 is positive. When the metadata MD_O recovered at the step 802 do not conform to the descriptor of the operation to be performed OP_DESC recovered at the step 803, the management device 111 rejects the response in a step 806, which ends the method. This is because this means that the smart meter 150 in question has performed an operation other than the one required, or that the response has been altered on the way. The management device 111 can therefore not trust the output attributes ATT_O received. Otherwise, a step 807 is performed.

In a step 807, the management device 111 recovers, in the response received, and verifies, by means of the public key of the smarts meter 150 that transmitted the response, that the signature conforms to the output attributes ATT_O and the metadata MD_O, which were recovered at the step 803.

Then, in a step 808, the management device 111 tests whether the verification of the step 807 is positive. When the signature conforms to the output attributes ATT_O and the metadata MD_O, a step 809 is performed. Otherwise, the step 806 is performed.

In the step 809, the management device 111 accepts the response, noting that is has not been altered during routing thereof from the smart meter 150 that sent it. The output attributes ATT_O can then be used by the management device 111.

For example, by means of the algorithm in FIG. 8, the management device 111 can verify that a command to read a security-events diary has been implemented in accordance with what was initially demanded, without alteration. This is because a modification on the way of an OBIS code that specifies the operation to be performed could lead to returning the content of another diary of events leading, for example, to conclude erroneously that no notable event has occurred.

Other checks can be made by the smart meter 111, in particular concerning the metadata MD_O. For example, the management device 111 can verify that the date of the response (“date-time” metadata) is not too old compared with an elapsed time limit threshold. Thus the smart meter 150 can verify that the cryptographic identity of the signatory (“originator-system-title” metadata and/or cryptographic identity of the recipient (“recipient-system-title” metadata) conform to expected identities.

In a particular embodiment, the method of FIG. 8 is also implemented by the data concentrator DC 120, since the data concentrator DC 120 has knowledge of the public key corresponding to the private key used by the smart meter 150 in question for generating the signature. Thus, if the data concentrator DC 120 is a trusted device, this makes it possible to verify, before relaying the response to the management device 111, that the response has not been altered on the interface I2 and to reject it without forwarding it to the management device 111 where applicable.

1. A method for transmitting a response to a command received by a smart meter in an automated management system, the command received comprising a descriptor of an operation to be performed by said smart meter, the method comprising the following steps performed by said smart meter, after performance of the operation demanded, to provide the response to the command received:
recovering output attributes, and metadata associated with the response, to be supplied as results of the implementation of the command received;
including, in the metadata associated with the response, the descriptor of the operation to be performed that had been supplied in the command received;
implementing a protection that generates a signature on a set of data formed by the output attributes and the metadata associated with the response;
transmitting, in response to the command received, the response including the output attributes, said associated metadata including the descriptor of the operation to be performed that had been supplied in the command received, and the signature generated.

2. The method according to claim 1, wherein the command furthermore includes metadata associated with the command, including a copy of the descriptor of the operation to be performed, and wherein the smart meter verifies that the descriptor of the operation to be performed and the copy thereof in the metadata associated with the command received are identical and, when such is not the case, the smart meter rejects the command received.

3. The method according to claim 2, wherein the smart meter constructs the metadata associated with the response by copying the metadata associated with the command received.

4. The method according to claim 1, wherein the descriptor of the operation to be performed contains an identifier of the operation to be performed.

5. The method according to claim 1, wherein the automated management of smart meters is implemented in accordance with an object-oriented modelling, the descriptor of the operation to be performed contains a class identifier of at least one object manipulated to perform the operation in question.

6. The method according to claim 5, wherein the object-oriented modelling is of the COSEM type and the protection that generates the signature is obtained by an object of the DATA PROTECTION type.

7. The method according to claim 1, furthermore comprising the following steps, on reception of the response, of verifying the response, performed by a management device that transmitted the command to said smart meter:
recovering, in the response received, the output attributes that result from the operation performed, as well as the metadata associated with the response;
recovering in memory the descriptor of the operation to be performed that had initially been transmitted in the command to which the response corresponds;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

8. The method according to claim 7, wherein the verification of the response is also implemented by a data concentrator acting as a relay between the management device and the smart meter in question in the automated management system.

9. A smart meter configured to process a command received in an automated management system, the command received comprising a descriptor of an operation to be performed by the smart meter, characterised in that the smart meter comprises electronic circuitry configured to perform the following steps, after performance of the operation demanded, to provide the response to the command received:
recovering output attributes, and metadata associated with the response, to be supplied as results of the implementation of the command received;
including, in the metadata associated with the response, the descriptor of the operation to be performed that had been supplied in the command received;
implementing a protection that generates a signature on a set of data formed by the output attributes and the metadata associated with the response;
transmitting, in response to the command received, the response including the output attributes, said associated metadata including the descriptor of the operation to be performed that had been supplied in the command received, and the signature generated.

10. A management device comprising electronic circuitry configured to implement a transmission of a command in an automated management system, the command comprising a descriptor of the operation to be performed by a smart meter, the electronic circuitry being configured to perform the following steps, on reception of the response, of verifying the response:
recovering, in the response received, output attributes that result from an operation performed by the smart meter on reception of the command, as well as the metadata associated with the response;
recovering in memory the descriptor of the operation to be performed that had initially been transmitted in the command;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

11. The system for automated management of plural smart meters comprising a management device and the plural smart meters each being the smart meter according to claim 9, the management device comprising electronic circuitry configured to implement a transmission of a command in an automated management system, the command comprising a descriptor of the operation to be performed by the smart meter, the electronic circuitry being configured to perform the following steps, on reception of the response, of verifying the response:
recovering, in the response received, output attributes that result from an operation performed by the smart meter on reception of the command, as well as the metadata associated with the response;
recovering in memory the descriptor of the operation to be performed that had initially been transmitted in the command;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

12. A method implemented by a management device in an automated management system, wherein the management device makes a transmission of a command comprising a descriptor of an operation to be performed by a smart meter, wherein the management device performs the following steps, on reception of a response to the command:
recovering, in the response received, output attributes that result from an operation performed by the smart meter on reception of the command, as well as the metadata associated with the response;
recovering in memory the descriptor of the operation to be performed that had initially been transmitted in the command;
verifying that the metadata recovered in the response correspond to the descriptor of the operation to be performed recovered in memory, and, when such is not the case, rejecting the response;
recovering the signature, in the response received, and verifying that the signature conforms to the output attributes and the metadata associated with the response, which were recovered in the response, and, when such is not the case, rejecting the response, and otherwise accepting the response.

13. (canceled)

14. A non-transitory information-storage medium storing instructions causing an implementation, by a processor, of the method according to claim 1, when the instructions are read from the information-storage medium and executed by the processor.

15. A non-transitory information-storage medium storing instructions causing an implementation, by a processor, of the method according to the method according to claim 12, when the instructions are read from the information-storage medium and executed by the processor.
